(19) United States
(12) Patent Application Publication
(10) Pub. No.: US 2006/0002783 A1
(43) Pub. Date: Jan. 5, 2006

(54) Bolt assembly, method and device for release, and computer system

(76) Inventors: Dickory Rudduck, Chicago, IL (US); Michael J. Hort, Chatswood (AU); Nicholas A. Ng, Chicago, IL (US); Geoffrey D. Sizer, Chicago, IL (US)

Correspondence Address: WILMER CUTLER PICKERING HALE AND DORR LLP, 399 PARK AVENUE, NEW YORK, NY, 10022, US

(21) Appl. No.: 11/133,747

(22) Filed: May 19, 2005

Related U.S. Application Data
(63) Continuation of application No. PCT/AU03/01539, filed on Nov. 19, 2003.

(30) Foreign Application Priority Data
Nov. 19, 2002 (AU) 2002953616
Dec. 9, 2002 (AU) 2002953229

(51) Int. Cl. F16B 39/00

(52) U.S. Cl. 411/107

(57) ABSTRACT

Quick release bolt assembly included shank and head of larger cross-section than that of shank. The screw thread of shank is adapted to rotatably engage with a complementary screw thread in a nut. Disengagement means are adapted in use to disengage the head or the nut without rotation of the nut or shank. The disengagement means includes a material such as shape memory alloy or epoxy resin, adapted to change form to facilitate engagement when activated. Activation may take place by a direct power supply or remotely by a radio frequency, magnetic, ultrasonic or infra red signal. Bolt can be used for anchoring seat belts. Computer systems and methods for the identification of a target, including enquiring as to the status of the target and having means to command the target to change the status are also disclosed and claimed.

### TECHNICAL FIELD

This invention concerns a new and improved bolt assembly, a method and device for releasing the bolt assembly and a computer system useful in relation to the foregoing, inter alia.

### BACKGROUND ART

A conventional bolt has a metal rod or pin with a head at one end and a screw thread at the other, to take a nut. The bolt is used to join one element to two or more other elements. One or more of the elements is usually mounted on the bolt between the nut and the head.

Such a prior art bolt is normally tightened by gripping the head of the bolt and rotating the nut, or vice versa. Conversely, to disengage the bolt, it is necessary to grip the nut or the head and rotate the head or the nut, respectively. The disengagement procedure can be slow, especially where access to the nut and/or the head is difficult. Tools are usually required in order to carry out the holding and rotation functions.

In some circumstances, delay in releasing a bolt can have highly undesirable consequences. For example, if bolts are used to anchor a seat belt in a vehicle, and the vehicle is subsequently involved in a collision, fast release of the seat belt anchors may be instrumental in saving the life of a person injured in the accident and hence unable to release the seat belt. Similar considerations may apply if the seat belt release mechanism has been damaged and cannot be released in the normal manner.

A quick release bolt could also be useful to enable release of vehicle doors in an accident.

### DISCLOSURE OF THE INVENTION

Accordingly, it is an object of this invention, at least in some embodiments, to provide a bolt which is capable of quick release, especially remotely.

While the bolt of the present invention has a wide range of applications and is capable of providing quick release, and optionally remote quick release, for convenience the invention will often be described below in connection with its use as a seat belt anchor.

As will be apparent to one skilled in the art, the invention is not limited to this application. In the automotive field alone, the bolt of the invention can be used, for example, to secure not only seat belts and doors but also spare tyres, roof racks and so on.

In one aspect, this invention provides a bolt assembly including:
a shank having a screw thread and
a head of larger cross section than that of the shank,
wherein the screw thread of the shank is adapted to rotatably engage with a complementary screw thread in a nut, characterised in that the bolt assembly includes means adapted in use to disengage the head or the nut without rotation of the nut or the shank, the disengagement means including a material adapted to change form to facilitate disengagement, when activated.

The bolt assembly may be of any suitable material, including plastic, but is preferably principally made of metal, especially steel. The shank is usually cylindrical as per conventional bolts. The head may resemble that of a conventional bolt; for example, the head may be hexagonal in cross section and designed to be engaged during assembly by a suitable tool for holding or rotating. The head may be integral with or separate from the shank. When the head is separate from the shank, the shank may include a socket or may be of a shape appropriate for engagement by a suitable tool, for holding or rotating during assembly.

In some embodiments, the head includes the disengagement means. In such embodiments, the head is designed to disengage from the shank. In other embodiments, the disengagement means may be included in the nut. In still other embodiments, the disengagement means may be included in the screw thread of the shank.

The disengagement means preferably includes a material responsive to an appropriate energy input in order to achieve the desired release. By way of example, the disengagement means may include shape memory alloy which, when heated to a transformation temperature, withdraws from engagement with a suitable ledge, groove or the like. As another example, the disengagement means may consist of or include a material, such as an adhesive, which can melt at a suitable temperature. In this way, the head of the bolt may disengage from the shank, or the relevant part of the nut may disengage, or the screw thread on the shank may disengage from that of the nut. In each case, disengagement permits an element trapped between the head and the nut to be freed from the shank, because the head has disengaged, or because the nut has disengaged or because the screw thread has withdrawn from engagement with the nut.

It should be apparent that any suitable material may be used to facilitate the disengagement. The examples described below in connection with the Drawings show use of shape memory alloy material or heat activatable epoxy resin (as an example of a “smart adhesive”). It is anticipated that other types of suitable materials may include photo polymers, magneto-rheological materials, “smart” gel as well as auxetic materials. Other options may be apparent to those skilled in the art.

The energy to activate the disengagement may be supplied by various means. Discussed or mentioned below are hard wiring (FIGS. 1, 2 and 4). Remote activation is possible as an alternative. This can be effected by, for example, using magnetic or ultrasonic energy or by triggering an exothermic or pyrotechnic reaction.

Reference is made to International Patent Application No. PCT/AU99/00185, the contents of which are incorporated herein by reference.

In connection with the device of the invention, this can incorporate features disclosed in International Patent Application No. PCT/AU01/00812, the contents of which are incorporated by reference. Preferred methods of data communication are ultra high frequency, radio frequency and infra red energy.

Where remote activation or communication is not required, data delivery can be via copper wire or fibre optic cable.

The shape memory material used in some embodiments of the invention is known. There are several of these. Currently, the best known is a shape memory alloy, predominantly or types made of titanium and nickel, but which may also include other material, such as aluminium, zinc and copper. Such a shape memory alloy is capable of adopting one shape below a predetermined transformation temperature and changing to a different shape once its temperature exceeds the transition temperature. In many cases, when a shape memory alloy cools below the transition temperature, it is capable of adopting the first shape again.

While this invention encompasses use of the shape memory alloy referred to above, it is not limited to this material. It is contemplated that other suitable materials may exist now or may come into existence in the future which can be substituted for the shape memory alloy.

As indicated above, there is no need to use a conventional tool to rotate the head of the bolt or the nut to cause this disengagement. As a result, it is possible to have rapid disengagement, compared to the prior art situation, where disengagement of the nut from the shank was possible only after either the shank or the nut had been rotated sufficiently to disengage the respective screw threads.

In another aspect, the invention provides a method for releasing the bolt assembly of the invention when engaged with the nut, the method including the step of activating the material to change form sufficiently to enable disengagement of the head or the nut without rotation of the nut or the shank.

Preferably, the method of the invention is carried out remotely by use of a special tool.

Accordingly, in a third aspect, the invention provides a device for release of the bolt assembly of the invention when engaged with the nut, the device including means for conveying a wireless command for activating the material to change form sufficiently to enable disengagement of the head or the nut without rotation of the nut or the shank. The wireless command may be provided by any suitable delivery means but is preferably chosen from the following options: magnetic, electromagnetic, ultrasonic, infra red, microwave or radio frequency energy.

While it is preferred to release the bolt assembly remotely, it is to be understood that the bolt assembly may be hard wired. In particular, where the bolt assembly is used in the context of an automobile, and whether or not it is intended that remote release will be used to disengage the bolt assembly in the case of an accident, the bolt assembly may be normally hard wired into the automobile's system, especially into an on-board computer system (when present). In this way, the vehicle can run a check on the status of the bolt assembly system at each engine start up and can report any failure, in the same way as many vehicles check the viability of brakes, lights and air bags on start up, at present. Hard wiring also enables the bolt assembly of the invention to make use of the general power source for the vehicle, such as the vehicle battery.

Regardless of whether the bolt assembly of the invention is hard wired, when it is used in an automotive context it may be preferred that the bolt assembly includes its own power supply. In case of vehicle crash, where the power supply may be damaged or severed, the local power supply for the bolt assembly can ensure that remote disengagement is possible, if that is desired. Local power supply may be provided by a small battery, by chemical means, by a capacitor, by compressed gas, by a clockwork system or in any other suitable way.

It is greatly preferred that the bolt assembly of the invention is capable of being manipulated during assembly by regular, conventional tools. In some embodiments, the bolt assembly of the invention is capable of assembly and disassembly repeatedly, including by quick release. In other embodiments, the bolt assembly of the invention can be assembled and disassembled in the conventional way any number of times (i.e., by rotating the nut or the shank), but quickly released only once (i.e., by disengaging the head or the nut without rotation of the nut or the shank).

It is desirable that the bolt assembly of the invention, when designed to be remotely activated, can be activated only by authorised personnel via an encrypted message from a hand-held version of the device of the invention. This is especially desirable when the bolt assembly of the invention is used to anchor seat belts in a vehicle. It is preferred that the bolt assembly of the invention is uniquely identifiable and that it is capable of being networked to other bolt assemblies in the vehicle or to other “intelligent” fastening systems. The purpose of this is to ensure that seat belt anchors and the like are not disengaged inadvertently or as a result of mischief.

Similarly, it is preferred that the device of the invention can be used only by authorised persons after biometric identification and/or entry of a code or pin number. In this way, the device of the invention may be used only by authorised personnel via an encrypted message from a hand-held device. Biometric identification may identity any convenient part of the user, such as a hand, a digit, a retina, and so on.

Specific examples of the bolt assembly of the invention are described below, in connection with the drawings.

In a typical example, the bolt assembly of the invention is initially assembled in a conventional way and is adaptable to conventional manufacturing processes. For example, in the case of an anchor for a seat belt, the shank of the bolt assembly is installed through a seat belt mounting plate and into the vehicle chassis. A nut is screwed onto the thread of the shank. The shank is tightened into the nut, either by holding the nut and rotating the head of the bolt assembly, or vice versa, or by using a socket recess in the end of the shank. The first two procedures are those conventionally used in nut and bolt assembly. The third procedure (use of a socket recess) is specific to the bolt assembly of the invention, which may not have a head suitable for holding or rotating by a conventional tool.

In this typical example, when it is desired to quickly disengage the bolt assembly by remote means, the device of the invention is used. This has a reader plate to permit an authorised user to press a thumb print into the plate and to obtain biometric authorisation. As well or alternately the user can enter a pin number to obtain authorisation. Authorisation may be on a plurality of levels, depending on the class of user. Both these procedures are well known. Next, by pressing one or more buttons on the device, the user, once authorised, may cause the device to communicate with a chip embedded in the bolt assembly. The chip is readable as to information including the unique identity of the bolt assembly and its status. Communication between the device of the invention and the bolt assembly may be, for example, by radio frequency, ultrasound or any other suitable wireless technology.

After identification of the bolt assembly, the device of the invention is used to trigger the release process, for example by causing heat energy to be supplied to material within the bolt assembly to enable disengagement of the head, or the nut.

After disengagement, it is preferred that a spring incorporated in the bolt assembly pushes the nut or the head off the shank so that the seat belt mounting plate (in this case) is released and the seat belt can be removed. Of course, the spring may be omitted, especially when the bolt assembly is installed in a situation where the head of the bolt is attached to the shank and the bolt can easily be withdrawn from the nut.

The device of the invention may be designed to activate disengagement of a plurality of bolt assemblies of the invention, if desired, in a chosen sequence.

In yet another aspect, this invention provides a computer system and method which may be used with the bolt assembly and device of the invention and which may also be useful in other areas.

In this aspect, the invention provides a computer system including the following:
means for enquiring as to identification in a target;
means to receive identification data from the target;
a database for comparing the identification data with stored data; and
means for transmitting a command to the target to change status in the target.

The identification in the target is intended to be used for the purpose of establishing communications and addressing commands, such as a command to cause activation of the disengagement means.

The identification may take any suitable form but preferably is capable of storage in a non-volatile manner, in order to resist corruption and intentional or unintentional over-writing or reprogramming. It is also preferred that the identification is unique to the target.

By way of non-limiting example, the identification may comprise a serial number, a communications address or a temporary communications address, or any combination of these.

When the identification is a serial number, this is preferably a unique number which is programmed into the target and which consequently does not change throughout the life of the target.

When the identification is a communications address, this is preferably a communications or network address which may be assigned to the target at the time of installation, or when a network of targets is configured.

When the identification is a temporary communications address, this is an address which may be assigned to the target on a transient basis. This may be desired, for example, where the target is configured in a sub-network and use of the full, unique address of the target during a particular session will cause excessive communications traffic and/or require excessive processing overhead during the communications session.

The identification may be stored in the target in any suitable manner and in any suitable storage device. Preferably, the storage method is robust and uses known techniques, such as multiple redundancy storage with checksum or CRC protection, reinstatement of backup on detection of errors, etc. Preferably, the storage method includes measures to prevent unauthorised access or tampering with the unique identity.

Examples of storage devices are the following:
Hardwiring: this includes switches, jumpers, solder blobs and soldered links.
Non-volatile memory: this includes PROM (programmable read only memory), EPROM (erasable programmable read only memory), EEPROM (electrically erasable programmable read only memory), Flash memory, battery backed random access memory (RAM), ferromagnetic RAM and optical storage. Storage of the unique identity may be combined with the operating program code of a microcontroller.
Semiconductor: storage in this form can incorporate the unique serial number programmed during manufacture and capable of being read by a microcontroller.

The address or identity of the target may be encrypted. There are many forms of available encryption techniques which may be suitable to the present invention. By way of example, the following are mentioned.

The first example is link encryption, where each communications link in which the information may be intercepted is protected by encryption of information on that link. Information may appear unencrypted or “in the clear” at communications or control nodes, and may need to be protected by other means, such as physical access control—discussed further below—at those points.

The second example is end-to-end encryption, in which information is encrypted at its source and decrypted at its destination and does not appear “in the clear” at intermediate points in the communications links.

As a third example, both end-to-end encryption as well as transmission over individually encrypted links may be used to result in a hybrid system.

In relation to physical access control, it may be desirable to incorporate further security measures to prevent unauthorised access to a target or network of targets, especially where there is a high level of need to prevent any unauthorised party to control targets, change system settings or configurations or cause damage or disruption to the system for any reason.

While file encryption is one way to prevent unauthorised entry into a system, there are other ways of controlling access. Some non-limiting examples are set out below.

Physical access to a system and its elements may be prevented by physically isolating the system or making it difficult to locate. For example, wiring for the system can be disguised within the loom of a vehicle. As another example, spread spectrum wireless communication techniques can be used to hide radiated signals amongst radio noise. Use of spread spectrum wireless links or other communications methods, such as optical fibres, can make it difficult to intercept, modify, disrupt or jam commands or communications to the system.

By way of further example, secure methods of identification may be used. For example, biometric information techniques may be used to identify authorised personnel and/or systems. Electronic security certificates may be required to authorise access by computer based systems. Valid access may require confirmation by personnel or systems by a bidirectional handshake and identity confirmation process, or by such measures as call-back to an authorised telephone number or a network address, for example.

By way of further example, access to and control of targets may require the operator or control system to take part in a dialogue with a master control/database for a specific access code, in order to allow control of the target. As well as such explicit authorisation, there may be tracking of the transaction. For example, the access code and target operation may be recorded in a time stamped log stored by the master control/database, by the target itself or by intermediate system elements. Retrieval of such logs can permit analysis for audit tracking purposes.

The status of the target may be represented by, for example, whether the target (if a fastener) is engaged or disengaged, whether it has been damaged (such as by tampering or mechanical stress), and so on.

In the context of the bolt assembly of the present invention, the computer system of the invention can read a chip in the bolt assembly containing information as to the unique identity of the bolt assembly and its status. Both data as to the identity and the status are sent back to the enquiring means and, in each case, compared with a database stored in the computer system. If the identity of the bolt is found in the identification database, the computer system can transmit a command to the target (the bolt assembly) to change the status, for example by switching on a heat source which can change the state of shape memory alloy as described in some of the examples in connection with the drawings, below.

Optionally, the computer system of the invention also includes means for enquiry as to the identification of a user, means to receive identification data from the user, a database for comparing the identification data with stored data and means to inactivate further use of the computer system if the identification data is not found in the database.

As another option, the computer system may include means for enquiring as to history of the target, means to receive history data and means to store the history data.

The history of the target (if a fastener) can include whether the fastener has been engaged or disengaged previously and, if so, the number of times this has occurred. The history data may be used to determine whether the target needs to be serviced and, if so, the type of service required.

As a further option, the computer system of the invention may recognise user identification on several levels and may restrict operation of the computer system accordingly. In the context of the bolt assembly invention, for example, a particular user may be authorised to change the status of the bolt assembly to quickly release it, but not to enable reassembly.

Where not already described, the choice of the elements in the computer system of the invention will be apparent to the person skilled in the art.

In some embodiments, the computer system may transfer data received and/or processed to a third party, such as another computer. This may occur in parallel (real time) or at a different time. The third party may have means to override authorisation to change status or in any other respect.

The computer system may be wholly or partly contained in a hand-held computer. It may be convenient if the device of the invention incorporates all or part of the computer system of the invention. For simplicity, the device of the invention may enquire as to the identification of the target, receive the identification data and send this data to a remote centre for comparison with stored data in a database. The remote centre may then authorise the device of the invention to authorise the change in status of the target, for example, by activating the disengagement means in the case of the bolt assembly of the invention.

It may be recalled that in a second aspect the invention provides a method for releasing the bolt assembly of the invention. This may be regarded as only one species of a different concept of method, which is also provided by this invention. The method includes the steps of:
enquiring as to identification in a target;
receiving identification data from the target;
comparing the identification data with stored data in a database;
enquiring as to status in the target;
receiving status data from the target;
comparing the status data with stored date in a database; and
authorising a change in the status.

Optionally, the last mentioned method may also include the steps of enquiring as to the identification of a user, receiving identification data from the user, comparing the identification data with stored data in a database and authorising the steps set out immediately above (enquiring as to identification in a target, etc).

As another option, the method may include the steps of enquiring as to the history of the target, receiving history data from the target and perhaps storing the history data in a database. As further options,, the method may include the step of transferring data to a third party.

The tool of the present invention may incorporate means to enable the computer system and method of the invention to operate.

The computer system and the process of the invention may be used in a situation where a service is being provided to a third party. For example, the service may involve the disassembly of apparatus and replacement or repair of a part which can only be located after disassembly. In such a service situation, the present invention allows automatic billing of the third party for whom the service is being carried out.

This can be achieved by including in the computer system means for obtaining payment for the service provided from a third party fund. The method associated with the computer system of the invention can include the step of requesting transfer of funds from the third party fund and authorising acceptance of the finds to a nominated fund.

It will be appreciated that using this procedure it is possible to bill automatically and to have the funds paid immediately for the carrying out of service to an apparatus.

### BRIEF DESCRIPTION OF THE DRAWINGS

The invention will now be described in connection with certain specific examples thereof. It is to be understood that these examples are not intended to be limiting on the scope of the invention in any of its aspects.

Reference is made to the accompanying drawings, in which:

FIG. 1 is side elevation, partly in cross section, of a first embodiment of the bolt assembly of the invention, in which the head of the bolt is designed to disengage;

FIG. 2 is a side elevation, partly in cross section, of a second embodiment of the bolt assembly of the invention, being a modification of that in FIG. 1;

FIG. 3 is a side elevation, partly in cross section, of a third embodiment of the bolt assembly of the invention, in which the nut is designed to disengage;

FIG. 4 is a side elevation of a fourth embodiment of the bolt assembly of the invention, in which the thread on the shank is designed to disengage;

FIG. 5 is a side elevation, partly in cross section, of a fifth embodiment of the bolt assembly of the invention, in which the head is designed to disengage;

FIG. 6 is a side elevation, partly in cross section, of a sixth embodiment, similar to that in FIG. 5, in which the head is designed to disengage;

FIG. 7 is a perspective view, partially cut away, of an embodiment of a tool which may be used as the device of the invention;

FIG. 8 shows a side elevation of the tool of FIG. 7 as part of a flow chart, also illustrating an embodiment of the computer system of the invention;

FIG. 9 is a block diagram illustrating an embodiment of the computer system of the invention where the target is in an “intelligent fastener”;

FIG. 10 is a block diagram showing a network of the fasteners of FIG. 9;

FIGS. 11 and 12 show different forms of encryption in relation to the intelligent fastener of FIG. 9;

FIG. 13 is a block diagram illustrating identification in the form of an address and a unique serial number; and

FIG. 14 shows how embodiments of various aspects of the invention can work in relation to fasteners in a motor vehicle.

### DETAILED DESCRIPTION OF THE DRAWINGS

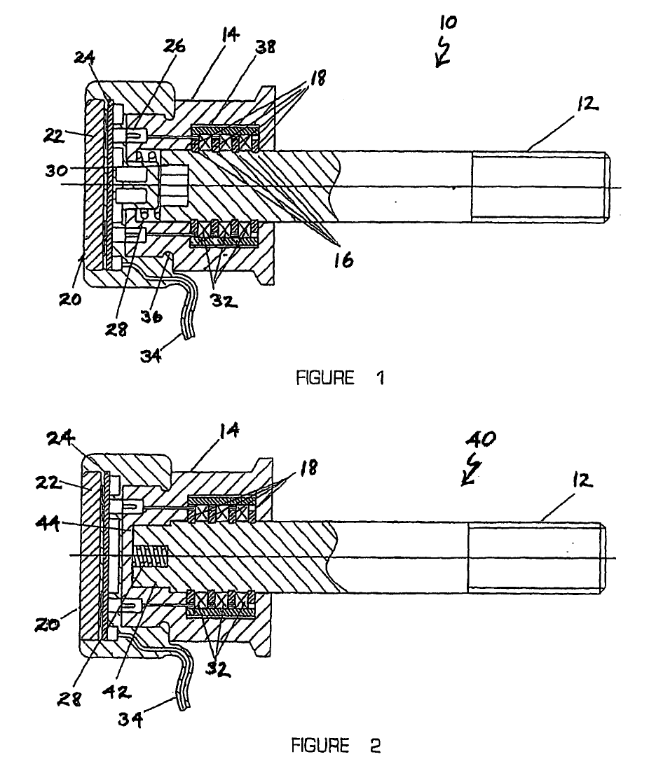

Referring first to FIG. 1, bolt assembly 10 has shank 12 with an external screw thread (not shown) adapted to engage a complementarily-threaded nut (not shown). Bolt 10 also includes head 14. In this embodiment, head 14 is not integral with shank 12 but forms a type of collar. Concentric grooves 16 are formed in shank 12. Head 14 includes shape memory alloy rings 18 which, in the state illustrated, fit into grooves 16 and retain head 14 on shank 12.

Bolt assembly 10 also includes controller head 20, which has a battery or capacitor 22 and a printed circuit board 24. Power and information travel via cable 34 which communicates with a power connector 26 on head 14. Spring 28 biases head 14 and controller head 20 away from shank 12.

Bolt assembly 10 also includes hexagonal drive socket 30 and heater elements 32. Electric power cable 34 connects bolt assembly 10 to the computer and power system of the vehicle (not shown).

Bolt assembly 10 may be used as a quick release bolt when activation is required within the vehicle from, for example, a dash board or console control. Bolt assembly 10 can be used in this environment to release a spare tyre or roof racks, for example. In that environment, power cable 34 would be used not only to monitor the status of bolt assembly 10 but also to deliver power and instruction to bolt assembly 10 to disengage. In that environment, battery or capacitor 22 may be omitted.

Power supply via cable 34 can be used to activate heater elements 32 and supply sufficient heat to shape memory alloy rings 18 to cause them to change shape and withdraw from grooves 16 in shank 12. At this stage, head 14 can be withdrawn linearly from shank 12, thus releasing any element trapped between head 14 and the nut (not shown) screwed onto the far end of shank 12 via a screw thread (not shown).

Conventional assembly of bolt assembly 10 is achieved by using an Allen key or similar conventional tool to tighten shank 12 within the nut (not shown), by inserting the Allen key into drive socket 30 and rotating. Controller head 20 is then pushed onto the end of head 14, snap fitting into recess 36.

Bolt assembly 10 is shown with four shape memory rings. The number of grooves 16 and hence the number of shape memory alloy rings 18 is dependent on the strength of the material used for the shank and for the rings, the dimensions of the grooves and the desired load capacity of the bolt. In the example illustrated, the depth of the grooves is designed to allow disengagement of the shape memory alloy rings (nickel titanium) at their maximum useable strain of 6%.

Head 14 fits in a tight sliding fit over shank 12, allowing shank 12 to rotate without appreciable play. When an Allen key or similar tool is used to rotate shank 12 to tighten the thread (not shown) on shank 12 into the nut (not shown), head 14 may be compressed against the part to be secured (such as a seat belt mounting plate), as is the case with a normal bolt head. If shank 12 is rotated in the opposite direction, head 14 is “backed off” from the seat belt mounting plate. As controller head 20 must be removed during the tightening or loosening process, the shape memory alloy rings 18 are encapsulated in head 14 in such a way as to transfer load from the rings 18 to head 14.

In this embodiment, head 14 is circular in cross-section, because no torque is applied to head 14 in the tightening or loosening process, this taking place via drive socket 30.

Shape memory alloy rings 18 are designed to be thin enough to ensure rapid heating but thick enough to give adequate shear strength. They are separated in grooves 16 in shank 12 to prevent over stressing of the shank material.

When heater elements 32 are activated to heat rings 18, once the transformation temperature has been reached, the crystal structure of the alloy in rings 18 transforms from martensite to austenite. For this application, it is envisaged that the material of rings 18 is nickel titanium material, class H, giving a transformation temperature (Active finish temperature Af) in the range of 95° to 115° C.

In this embodiment, heater elements 32 cause the transmission of compressive load from shape memory alloy rings 18 to the body of head 14. Heater elements 32 must therefore be made of a suitable material with regard to heating and mechanical properties. As necessary, heater elements 32 may need to be electrically insulated from metal components. In this case, the design may require adjustment from that shown in FIG. 1, or else heating may be carried out in a manner other than by electrical resistance heating. For example, an exothermic chemical reaction could be used, although this would limit the bolt assembly to a once-only release according to the method of the invention.

As an alternative, rings 18 can be used directly as resistance heaters, by supplying a current to the rings. In this case, rings 18 would need to be coated with an electrically insulating surface finish, such as polytetrafluroethylene (PTFE), in order to prevent short circuiting.

Once rings 18 have been heated in a suitable manner, and have expanded, head 14 is ejected, fully or partially, from shank 12 by spring 28. After rings 18 cool down, they are forced to return to the martensitic (room temperature) crystal structure or small diameter state by annular return spring 38, located around rings 18. In this embodiment, rings 18 will not return to the “small state” without the bias provided by return spring 38. Head 14 may be put onto shank 12 when rings 18 are in the austenitic crystalline structure (hot) or large diameter state. In the large diameter state, rings 18 do not engage in grooves 16.

In order to work in the desired way, it is necessary to “train” the shape memory alloy material used for rings 18. A one-way memory may be employed to achieve the desired strain of 8%, with return spring 38 being used to restore the low temperature state on cooling. The “training” of rings 18 may be conducted by constraining the rings to the desired small diameter shape, heating rings 18 to between 400° and 500° C. and then rapidly cooling them by water quenching or air cooling.

Referring now to the embodiment in FIG. 2, this is similar to the embodiment in FIG. 1. However, in the FIG. 2 embodiment, shank 12 terminates in a hexagonal (or other suitable shape) spigot 42. This engages in socket 44 in head 14.

Whereas in bolt assembly 10 in FIG. 1 drive socket 30 was used to tighten or loosen shank 12, in the case of bolt assembly 40 in FIG. 2 the external surface of head 14 is hexagonal to resemble the shape of a normal bolt head and can be used to tighten or loosen the bolt. Controller head 20 (for delivery of power and data) is placed over head 14 after the desired amount of tightening or loosening has taken place, as was the case with bolt assembly 10 in FIG. 1.

Bolt assembly 40 can be used for the same applications as those described for bolt assembly 10.

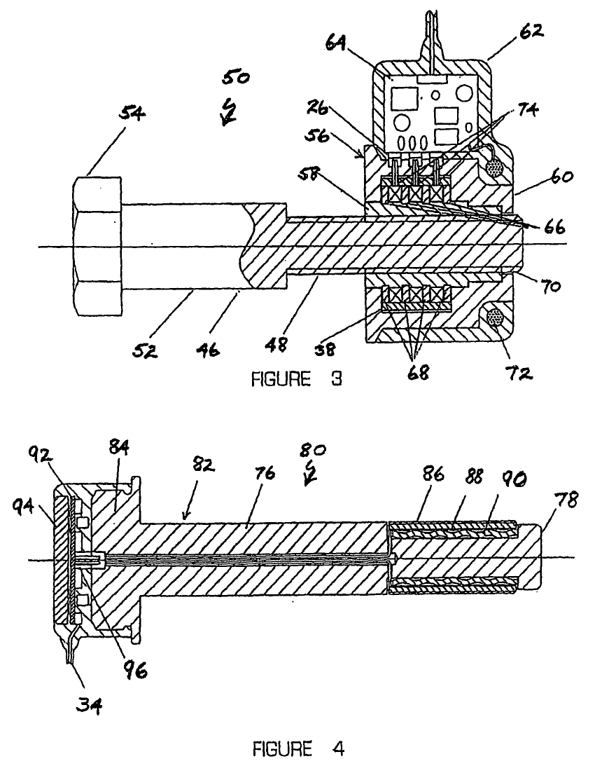

Referring now to FIG. 3, this shows bolt assembly 50 in which the disengaging means forms part of the nut rather than the head of the bolt. This form of the invention can be particularly useful where a flush design is preferred, the bolt to be inserted in the nut when required, for example when installing child seat restraints.

In this embodiment, shank 52 has two different cross sectional sizes. The first part 46, is of larger size and is on that part of shank 52 which is attached to or integral with traditional bolt head 54. The second part 48 is of a smaller size, for the purpose explained below.

Nut 56 has two main parts, sleeve 58 and collar 60. Sleeve 58 has approximately the same cross sectional size as first part 46 of shank 52. Consequently, when sleeve 58 is mounted on second part 48 of shank 52, bolt assembly 50 (minus collar 60) can pass through a standard sized bolt hole. Alternately, shank 52 may be of uniform size (as for first part 46) and sleeve 58 would have a larger cross sectional size than part 46. The bolt hole would need to be larger.

Sleeve 58 includes a number of grooves 66 in which are inserted shape memory alloy rings 68. Return spring 38 is as described in connection with FIG. 1. Rings 68 prevent axial movement of collar 60 on sleeve 58.

The second part 48 of shank 52 also has a hexagonal or other suitably shaped up-stand 70 to engage with collar 60. Internally, sleeve 58 is threaded to mate with a complementary thread on second part 48 of shank 52 (the thread not being shown in this Figure).

Controller head 62 is attached to nut 56 and includes a printed circuit board 64 and a radio frequency coil 72. Heater elements 74 carry out a similar function to heater elements 32 in FIGS. 1 and 2. No ejector spring is shown in the embodiment in FIG. 3. This can be included if desired but may not be necessary, because once rings 68 are heated in order to change shape and disengage from grooves 66, conventional bolt head 54 may be gripped to withdraw the bolt from nut 56.

To activate shape memory alloy rings 68 (by heating them sufficiently to change shape), a device of the invention (not shown) transmits a radio frequency signal to coil 72 and printed circuit board 64 processes the signal to heater elements 74.

Turning now to the embodiment in FIG. 4, in this embodiment the thread on the shank is made from shape memory alloy.

In this embodiment, bolt assembly 80 has head 84 and shank 82. Shank 82 is in two parts. The first part 76 is integral with part of head 84. The second part 78 includes thread 86 made of shape memory alloy material. Insulating material 88 is inserted between thread 86 and second part 78 of shank 82. A return spring 90 is incorporated between thread 86 and insulating material 88.

Head 84 includes a printed circuit board 92 and a capacitor 94. Power connector 96 provides power and data from an external source via cable 34 through the centre of first part 76 of shank 82 to thread 86.

When power is supplied to thread 86 via power connector 96, thread 86 contracts at its transformation temperature, causing a change in diameter sufficient to fully disengage thread 86 from a nut (not shown) mounted on it. Because current material technology allows only an 8% reduction in diameter, a special low profile thread is required. This may change as technology develops. A low profile thread may have a significantly lower load rating than a standard thread. Increases in permissible strain can increase the load rating of the fastener.

Bolt assembly 80 may be suitable for a once-only quick-release use (according to the method of the invention). Alternately, the shape memory alloy may be trained to assume the threaded configuration when it cools and bolt assembly 80 may be reusable in accordance with the method of the invention as required.

Preferably, at the transformation temperature, thread 86 changes from a threaded cylinder to a smooth cylinder, to aid linear withdrawal from the nut.

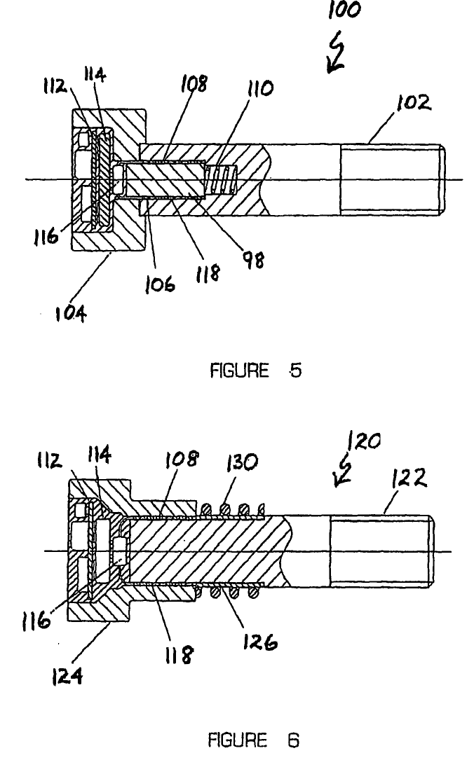

The embodiment in FIG. 5 is particularly useful for once-only applications, for example in the case of remotely releaseable door hinge mounts, etc. These could be used to release doors in the case of vehicle accident where occupants are trapped inside the vehicle, for example.

In FIG. 5, bolt assembly 100 has head 104 and shank 102, bearing threads (not shown) to engage a nut (not shown). Head 104 is not integral with shank 102 but is engaged by inserting hexagonal or other suitably shaped spigot 98 in complementary cavity 106 in shank 102. Head 104 is secured in engagement in cavity 106 by heat activatable epoxy adhesive 108, against the bias provided by ejector spring 110.

Head 104 also includes printed circuit board 112, battery or capacitor 114 and switch 116.

When switch 116 is activated, adhesive 108 is heated and becomes viscous. The bond between spigot 98 and cavity 106 is broken and spring 110 ejects head 104 from shank 102. Heating can take place via a battery powered heating coil 118 or else an exothermic reaction can be used.

With reference now to the embodiment in FIG. 6, bolt assembly 120 is similar to bolt assembly 100 in FIG. 5, except that head 124 engages the outside of shank 122, ejector spring 130 is external to shank 122 and insulator 126 is included.

Head 124 includes printed circuit board 112, capacitor or battery 114 and switch 116.

Adhesive 108 provides sufficient bond between head 124 and shank 122, in the unheated state, to permit torque to be transmitted from head 124 to shank 122, as well as providing sufficient shear load to cope with the rated axial load of the bolt.

It will be appreciated from the description of the above specific embodiments that the disengaging means can be incorporated in the head of the bolt, as in FIGS. 1 and 2, in the nut as in FIG. 3, in the thread as in FIG. 4 or between the head and the shank as in FIGS. 5 and 6.

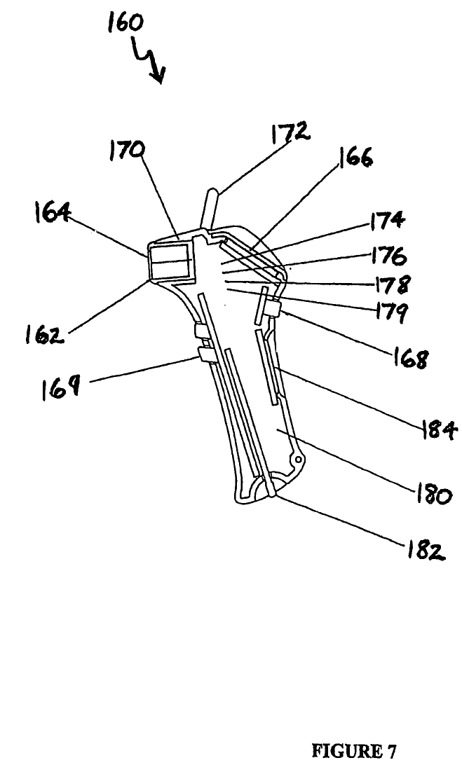

With reference to FIG. 7, tool 160 has an actuator 162 and a detector 164 as well as a read-out screen 166 and user interface/menu selection buttons 168. Tool 160 also includes a modular head 170 (so that the module containing actuator 162 and detector 164 can be exchanged for a different module which may link to a different process of activation and/or detection).

Tool 160 also includes an aerial 172 for reception and transmission, communication module 174, processing module 176, memory module 178 and switching module 179. Tool 160 has power supply 180 and insertable external memory card 182. In the embodiment shown, tool 160 also has biometric authorisation means 184, so that use of tool 160 can be authorised by detection of an acceptable thumb print, for example.

By use of buttons 168, tool 160 may be placed into any one of several different modes. In one mode, detector 164 can detect the identity of a bolt assembly (not shown). In the same or a different mode, detector 164 can diagnose the status of a bolt assembly—for example, whether the bolt assembly is in the fixed or released state or whether it has been damaged. Tool 160 may then interpret the action required in relation to a particular bolt assembly and display this on screen 166. In yet another mode, tool 160 can send a command to the bolt assembly, for example, to cause it to disengage. Tool 160 can also record relevant information, by transferring it to the bolt assembly or by recording it in tool 160 itself or by transmitting it to a remote data centre.

To further detail the type of functions of tool 160, it may determine security issues, such as whether the person using tool 160 or tool 160 itself is authorised to activate the bolt assembly. Tool 160 can record the service history of the bolt assembly. Lastly, tool 160 can send a command to activate the bolt assembly.

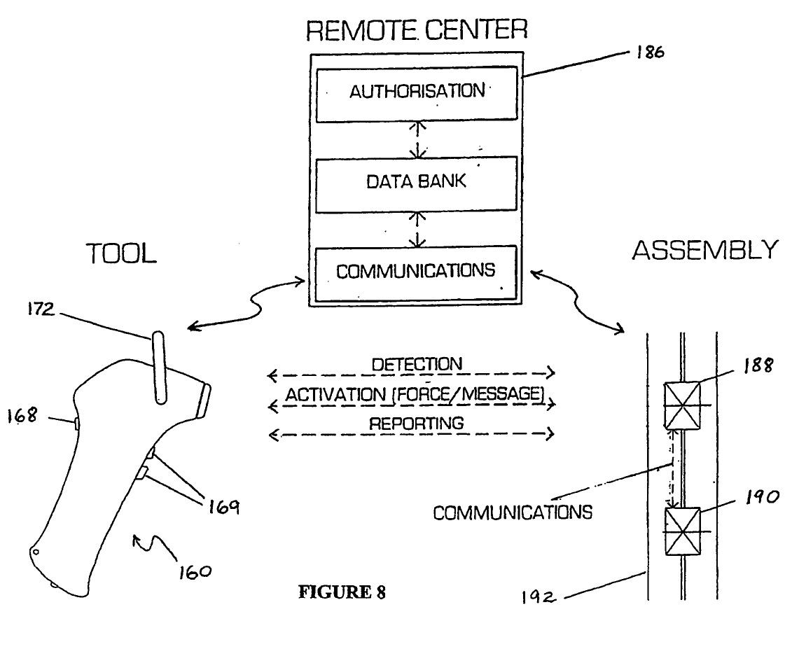

Turning now to FIG. 8, tool 160 is shown in the flow chart in its relationship with remote centre 186 and bolt assemblies 188 and 190 in wall assembly 192. As indicated, tool 160 can interrogate bolt assembly 188 and receive information from it. Tool 160 can activate bolt assembly 188 by applying a force or sending a message. Tool 160 can report to bolt assembly 188 and receive a report from bolt assembly 188.

While tool 160 can repeat these functions in relation to bolt assembly 190, it is also possible to have communication between bolt assemblies 188 and 190 themselves.

In summary, the link between tool 160 and bolt assembly 188 allows detection and reporting of identity, status, sequence, history and authorisation requirements. This can be done using infra red, radio frequency, electromagnetic, microwave or ultrasound energy, amongst others. Tool 160 can also command the disengagement means in bolt assembly 188 to activate, using any of the above forms of energy and also by using digital instruction, alone or in combination with energy transmission and also variations such as electromagnetic pulse and induction.

The link between tool 160 and remote centre 186 can permit the downloading of manuals, instructions, procedures and customer files, the giving of authorisation, billing, encryption control of bolt assemblies, the uploading of service information, diagnostics, information as to parts replaced, the facilitation of inventory, and the location and history of bolt assemblies.

Also shown is a link between remote centre 186 and bolt assemblies 188. This link can provide reports on status, relay history, provide diagnosis and control encryption links.

While examples have been given above of the way in which functions carried out by tool 160 may be effected, it is to be understood that these functions may be carried out in any suitable way and, as will be appreciated by one skilled in the art, there already exists relevant technology which can be adapted for this purpose.

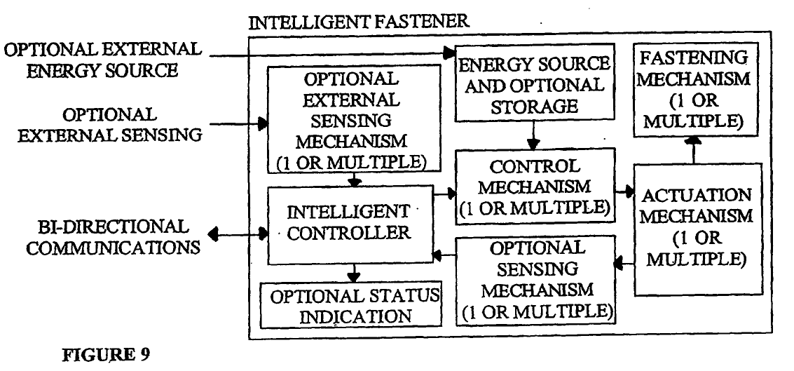

Referring to FIG. 9, the target in accordance with the computer system and method of the invention is in an intelligent fastener in this embodiment. The block diagram is essentially self-explanatory.

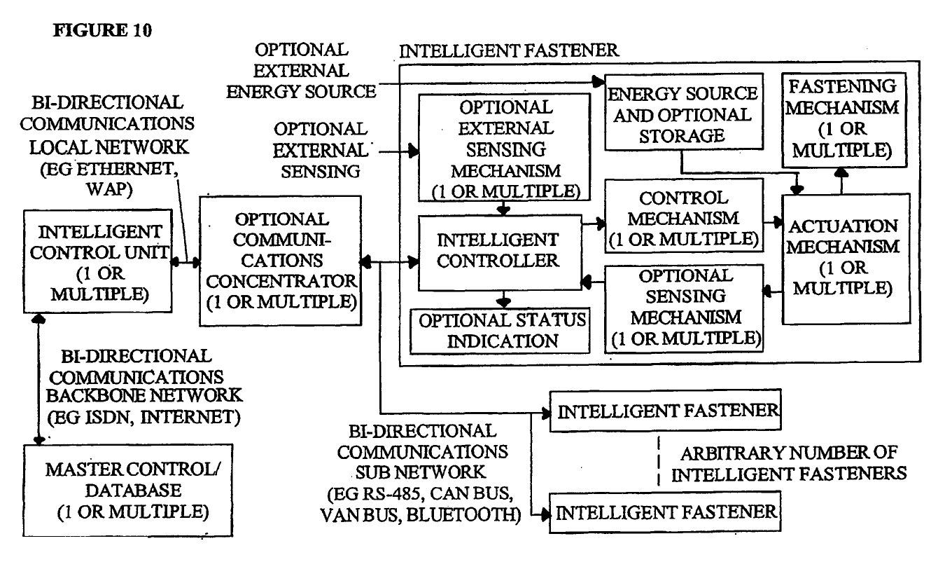

In FIG. 10, there is a system of intelligent fasteners, each as shown in FIG. 9.

The communications concentrator, which is an optional element, provides a mechanism for partitioning system complexity, e.g., by providing an interface between a relatively costly-to-implement radio frequency network and an inexpensive RS-485 network which interconnects a number of the fasteners via a subnetwork. The subnetwork may use any communications which may also be useful for the intelligent fastener, such as unidirectional, bidirectional, full duplex, half duplex, simplex, point-to-point, network, asynchronous and synchronous, via such techniques as electromagnetic radiation, radio (AM or FM), magnetic coupling, low frequency RF, microwave radio, spread spectrum radio, light (visible, infrared), optical fibre, electrical (wire, cable) or sonic (ultrasonic, audible or infra-sound).

The intelligent control unit may be a discrete device, an integrated circuit, a microcontroller, a microcomputer, a programmable logic device, a hybrid integrated circuit, an application specific integrated circuit, a printed wiring assembly or an embedded PC.

The optional sensing mechanism may be binary, multi-state or linear and operate by any of the following techniques: electrical (switch, contact, strain gauge, piezo-electric, piezo-resistive, magneto-resistive, resistive), magnetic/Hall effect, capacitive, optical acoustic/ultrasonic or mechanical.

The status indication may be optical, acoustic or mechanical.

The control mechanism may also be binary, multi-state or linear. It may operate by techniques such as electrical (switch, relay/contactor, semiconductor, transistor, FET, thyristor, mechanical (lever, valve, piston) or biological (human or animal).

The energy source and optional storage may be local, external or a combination, using a technique such as primary or secondary cell or battery, mains derived power, capacitor or supercapacitor, electromagnetic radiation (RF or light), inductive coupling, acoustic, chemical, fuel cell, gravity, mechanical, kinetic or biological.

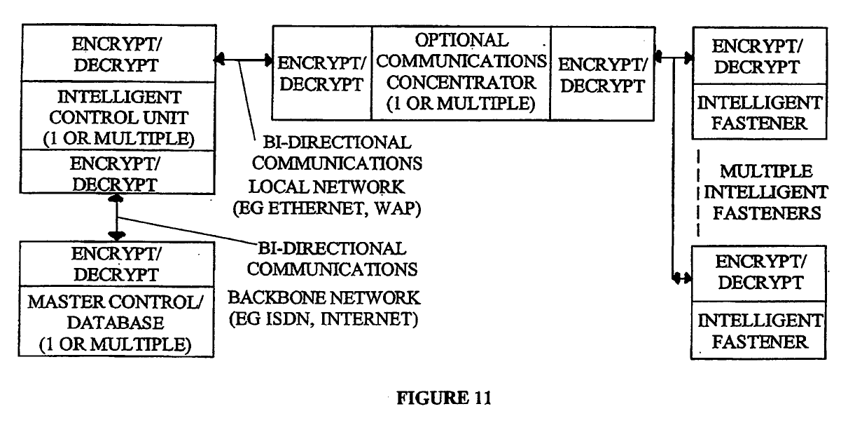

Turning now to FIG. 11, this illustrates a form of link encryption, in which each communications link where the information (address data) may be intercepted is protected by encryption of information on that link.

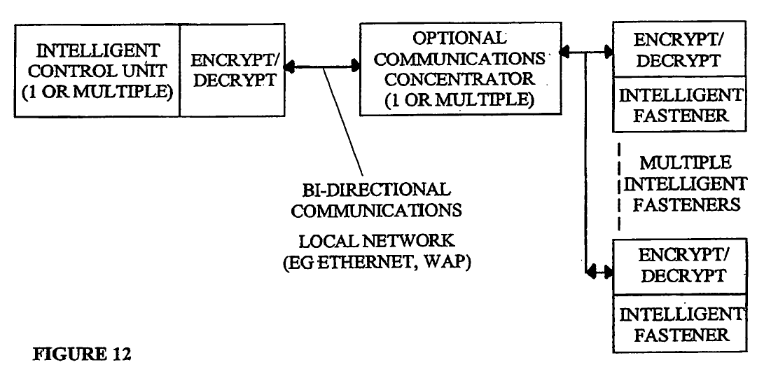

FIG. 12 shows a form of end-to-end encryption, where information is encrypted at its source and decrypted at its destination.

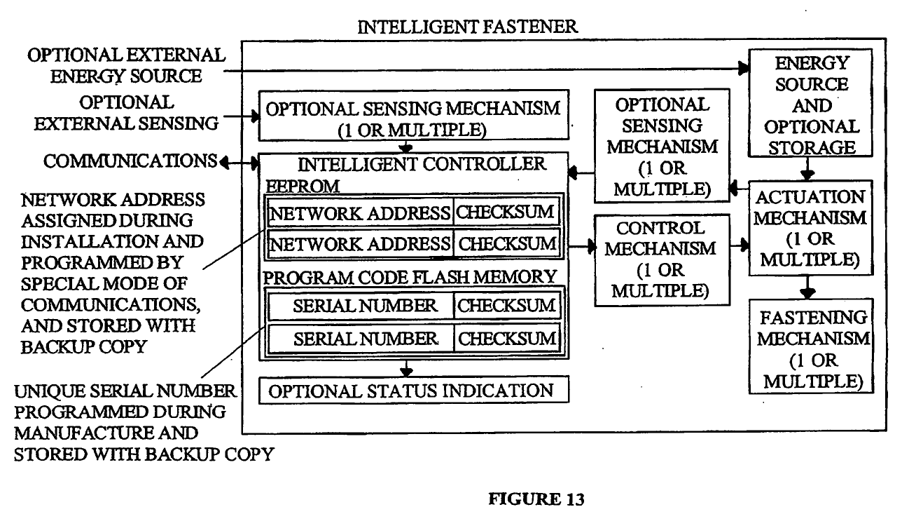

FIG. 13 shows storage of a unique identity for a fastener, using a microcontroller-based intelligent controller which incorporates internal program code memory programmed with a unique serial number during manufacture. Also included is an EEPROM which stores a network address programmed as part of installation and commissioning. Each of these is stored redundantly with checksum protection.

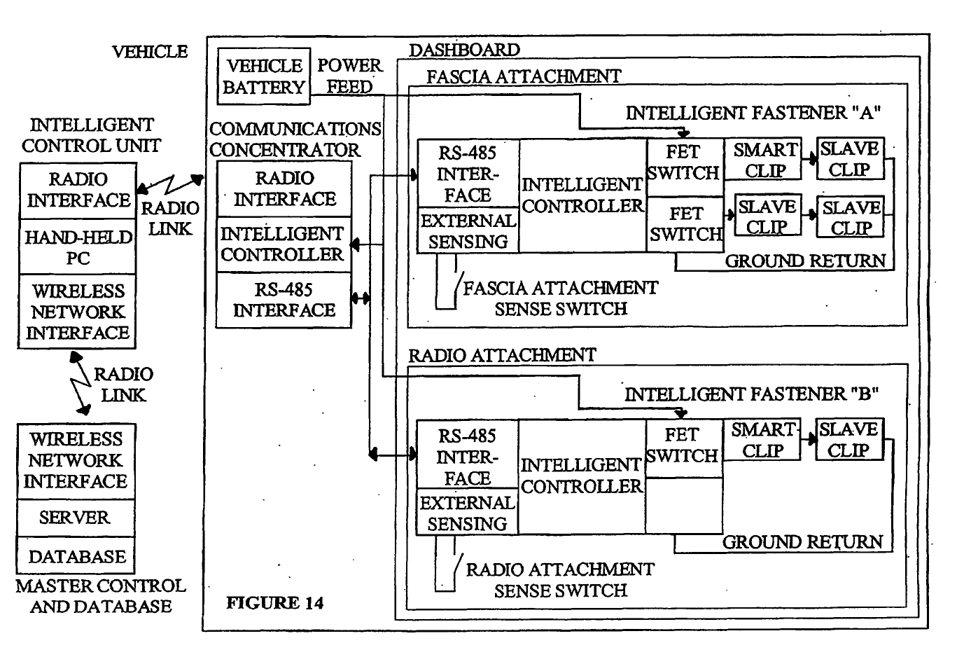

The block diagram in FIG. 14 embodies many of the concepts of the invention. The system shown consists of a fastening system for a car radio which is housed behind a fascia which must be removed before the radio can be removed or installed.

The fascia and radio are each retained by multiple fasteners similar to those shown in the early embodiments, above. The fascia is retained by intelligent fastener A which controls three “slave” fasteners wired in series/parallel combination. The radio is retained by intelligent fastener B which controls one slave fastener wired in series with the fastener. The intelligent fasteners have external sensing switches to determine whether or not the item attached by the fastener is in place. Power for fastener electronics and actuators is derived from the vehicle electrical system.

The handheld PC in the intelligent control unit runs custom software and the unit can report the installation or otherwise of the radio and fascia and can guide the operator through a step-by-step installation procedure.

The database in the master control unit may contain records relating to vehicles being serviced by the system.

### INDUSTRIAL APPLICABILITY

The bolt assembly of the invention has wide industrial applicability, especially where rapid release is required. For example, if used as a seat belt anchor, individuals in a severe automobile crash can be released from their seat belts where the individuals are disabled or where the seat belt release mechanism has been damaged.

It would be readily appreciated by one skilled in the art that the computer system and method (in the last aspect) of the invention are capable of extremely broad application, not limited to the environment of the bolt assembly invention disclosed in this document. For example, the system and method may be applied to the invention disclosed in International Patent Application No. PCT/AU99/00185, and may have other applications.

What is claimed is:

1. A bolt assembly comprising:
a shank having a screw thread and
a head of larger cross section than that of the shank,
wherein the screw thread of the shank is adapted to rotatably engage with a complementary screw thread in a nut, characterized in that the bolt assembly includes means adapted in use to disengage the head or the nut without rotation of the nut or the shank, the disengagement means including a material adapted to change form to facilitate disengagement, when activated.

2. The bolt assembly of claim 1, wherein the disengagement means is included in the head, the nut or the screw thread of the shank.

3. The bolt assembly of claim 1, wherein the material is chosen from the group consisting of a shape memory alloy and heat-activatable epoxy resin.

4. The bolt assembly of claim 1, wherein the material is a shape memory alloy and the disengagement means is adapted for use more than once.

5. The bolt assembly of claim 1, wherein the material is a heat-activatable epoxy resin and the disengagement means is adapted for single use.

6. The bolt assembly of claim 1, wherein the material in the disengagement means is adapted to be activated by wireless command.

7. The bolt assembly of claim 1, wherein the head is separate from the shank and the shank is adapted for engagement during assembly.

8. The bolt assembly of claim 7, wherein the shank contains a socket.

9. A method for releasing the bolt assembly of claim 1 when engaged with the nut, the method comprising the step of activating the material to change form sufficiently to enable disengagement of the head or the nut without rotation of the nut or the shank.

10. The method of claim 9, wherein activation follows a wireless command, using energy chosen from the group consisting of magnetic, ultrasonic, infra red and radio frequency energy.

11. A device for release of the bolt assembly of claim 1 when engaged with the nut, the device comprising means for conveying a wireless command for activating the material to change form sufficiently to enable disengagement of the head or the nut without rotation of the nut or the shank.

12. The device of claim 11, wherein the wireless command uses energy chosen from the group consisting of magnetic, electromagnetic, ultrasonic, infra red, microwave and radio frequency energy.

13. The device of claim 11 further comprising operator authorization means.

14. The device of claim 13, wherein the operator authorization means is adapted to require biometric identification and/or entry of a code.

15. The device of claim 11, wherein the device comprises bolt assembly identification means.

16. The device of claim 11, wherein the device is adapted to activate disengagement of a plurality of the bolt assemblies.

17. The device of claim 16, wherein the device is adapted to activate disengagement of the plurality of bolt assemblies in a chosen sequence.

18. A computer system comprising:
means for inquiring as to identification in a target;
means to receive identification data from the target;
a database for comparing the identification data with stored data; and
means for transmitting a command to the target to change status in the target.

19. A computer system comprising:
means for inquiring as to identification in a target;
means to receive identification data from the target;
a database for comparing the identification data with stored data;
means for inquiring as to status in the target;
means to receive status data from the target;
a database for comparing the status data with stored data; and
means for transmitting a command to the target to change the status.

20. The computer system of claim 18 further comprising:
means for inquiring as to the identification of a user;
means to receive identification data from the user;
a database for comparing the identification data with stored data; and
means to inactivate further use of the computer system if the identification data is not found in the database.

21. The computer system of claim 18 further comprising:
means for inquiring as to history of the target;
means to receive the history data; and
means to store the history data.

22. The computer system of claim 18, further comprising means limiting use of the computer system according to a predetermined type of user.

23. The computer system of claim 18, wherein the computer system includes means for transferring data to a third party.

24. The computer system of claim 18, further comprising means for obtaining payment from a third party fund.

25. The computer system of claim 18, wherein the identification is a serial number, a communications address or a temporary communications address.

26. The computer system of claim 18, wherein the target is the bolt assembly of claim 1.

27. The computer system of claim 26, wherein the command effects activation of the material.

28. A method comprising the steps of:
inquiring as to identification in a target;
receiving identification data from the target;
comparing the identification data with stored data in a database;
inquiring as to status in the target;
receiving status data from the target;
comparing the status data with stored date in a database; and
authorizing a change in the status.

29. A method comprising the steps of:
inquiring as to the identification of a user;
receiving identification data from the user;
comparing the identification data with stored data in a database; and
authorizing the steps set out in claim 28.

30. The method of claim 28, further comprising the steps of:
inquiring as to the history of the target;
receiving the history data from the target; and
optionally storing the history data in a database.

31. The method of claim 28 further comprising the step of transferring data to a third party.

32. Th
